(19) United States
(12) Patent Application Publication
(10) Pub. No.: US 2012/0291561 A1
(43) Pub. Date: Nov. 22, 2012

(54) Pipeline Insertion Tool

(76) Inventors: Willie V. Evans, Kilgore, TX (US); Gary K. Evans, Kilgore, TX (US)

(21) Appl. No.: 13/474,302

(22) Filed: May 17, 2012

Related U.S. Application Data
(60) Provisional application No. 61/486,934, filed on May 17, 2011.

(51) Int. Cl. G01N 3/02

(52) U.S. Cl. 73/788

(57) ABSTRACT

The apparatus mounts on a high pressure pipe and moves a witness coupon into and out of the pipe. A coupon holder assembly is secured to a driver. A coupon rod is engaged within the coupon holder assembly and the driver, wherein, an upper end of the coupon rod is engaged with the driver and a lower end of the coupon rod is positioned within the coupon holder assembly but may be driven in translation downwardly and out of the coupon holder assembly. A clamp may be engaged with the coupon rod securing it in a fixed position when the coupon rod is not being moved. A ball valve is used to isolate the apparatus from the high pressure pipe, and once isolated, a bleed valve is used to vent to atmospheric.

This application is a continuation based on a prior filed provisional patent application Ser. No. 61/486,934, filed on May 17, 2011 and claims international date priority therefrom. The subject matter of application 61/486,934 is hereby incorporated hereinto in its entirety.

### BACKGROUND

No federally sponsored research or development, and no sequence listing, table, or computer program listing compact disc appendix is applicable to this application.

This application relates generally to a pipeline corrosion detecting apparatus. More particularly, the it relates to an apparatus for inserting and retrieving coupons and atomizers from large diameter pipelines so as to periodically check for corrosion and wear of the pipeline due to fluid flow therein which may be corrosive or may be suspensions. It is known in the prior art that the flow of fluids or suspensions through pipelines can result in corrosion and deterioration of the pipeline on its interior wall surface. Underground or otherwise concealed pipelines are usually inaccessible. It has been the practice to insert test coupons into such pipelines. The test coupons are constructed of a suitable material such as the material of the pipeline itself, so that the corrosive effects on the coupon are indicative of that of the pipeline. In a large diameter pipeline, such as those in the 24 to 36-inch range, the apparatus for inserting the coupon generally includes an elongated shaft housing assembly engaged with the pipeline. A means for insertion and withdrawal of the coupon is provided within the housing assembly.

### BRIEF SUMMARY

The apparatus described herein is a tubular toot having a means for attachment to the side of a pipeline and a means for extending into a hole in the pipeline, a coupon that will experience wear and corrosion from the flow of fluids in the pipeline. The tool has a relief valve so that it may be brought to atmospheric pressure prior to being removed from the pipeline.

In one aspect of the apparatus, a coupon may be inserted into a pipeline and later withdrawn.

In another aspect of the apparatus a nozzle may be inserted into the pipeline to deliver a chemical there into and later the nozzle may be withdrawn.

In another aspect of the apparatus bleeder valve may be used to equalize pressure prior to removing the tool from the pipeline.

Other features and advantages of the present invention will become apparent from the following more detailed description, taken in conjunction with the accompanying drawings, which illustrate, by way of example, the principles of the presently described apparatus and method of its use.

### DRAWING DESCRIPTION

Illustrated in the accompanying drawings are at least one of the best mode embodiments of the present invention; in such drawings:

FIG. 1 is an example vertical cross-sectional view of a coupon holder assembly of the presently described apparatus;

FIG. 2 is an example perspective view of a rod driver assembly of the presently described apparatus;

FIG. 3 is an example partial perspective view of a base assembly thereof; and

FIG. 4 is a further example partial perspective view of the base assembly.

Identical reference numerals of the several drawing figures relate to the same element illustrated therein.

### DETAILED DESCRIPTION

The above described drawing figures illustrate the presently described apparatus and its method of use in at least one of its preferred, best mode embodiments, which is further defined in detail in the following description and the referenced drawing figures.

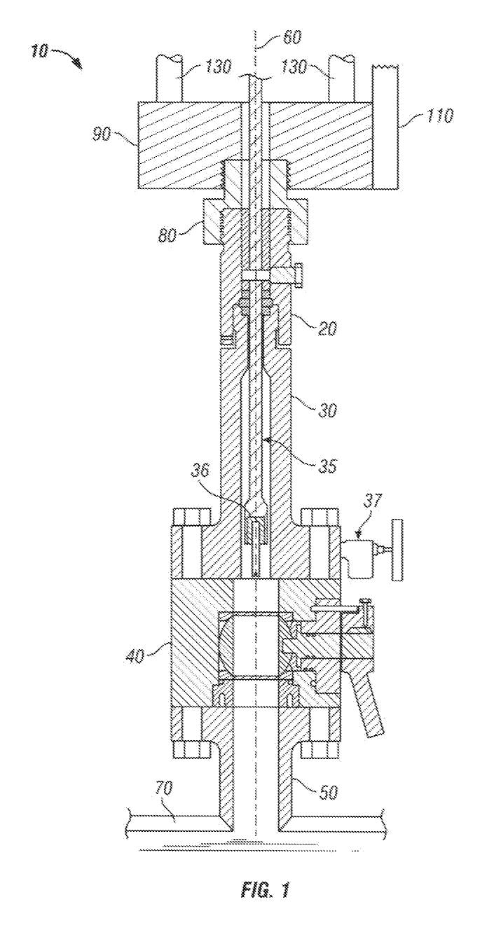

As shown in FIG. 1 a coupon holder assembly 10 may include a collet tube 20, a mounting tube 30, a valve assembly 40, and a pipe connector tube 50, all of which may be positioned in a coaxial arrangement about axis 60. The pipe connector tube 50 may be welded to one side of a pipe 70 as shown, (not a part of the presently described and claimed apparatus). As further shown in FIG. 1, a union adapter 80 may join collet tube 20 and with a base block assembly 90.

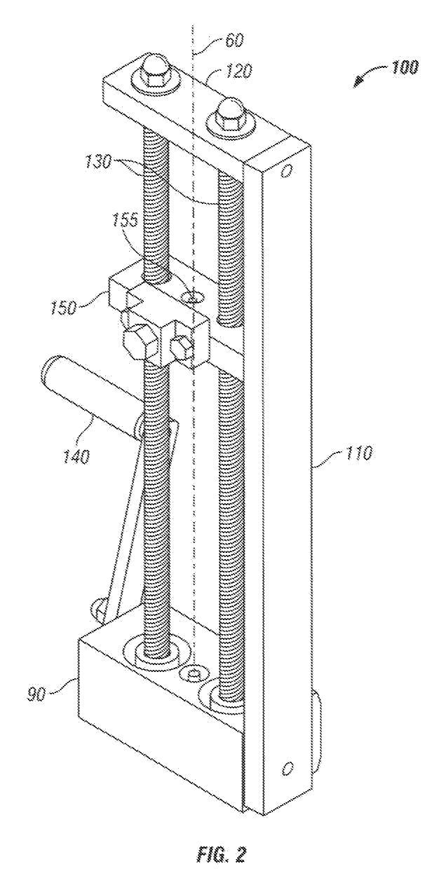

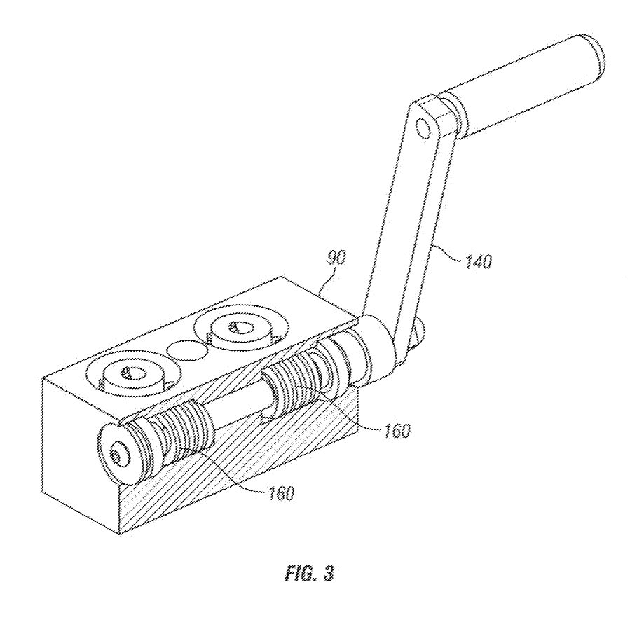

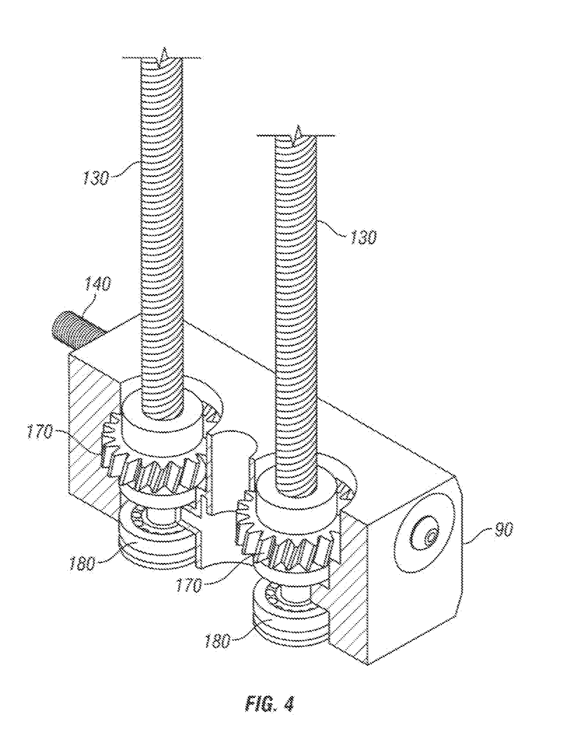

FIG. 2 illustrates driver assembly 100 which may include the base block assembly 90, an upright support 110, a top support 120, a pair of threaded shafts 130, a hand crank 140, and a rod clamp 150. The hand crank 140 may be replaced by an electric motor (not shown). The hand crank 140, or electric motor, may be engaged with a pair of worm gears 160 as shown in FIG. 3, which may be rotationally mounted within, as a part of, base block assembly 90. FIG. 4 shows that base block assembly 90 may also have, rotationally mounted therein, a pair of spur gears 170 engaged with worm gears 160, and a pair of bearings 180 wherein the spur gears 170 and bearings 180 may be engaged at one end of threaded shafts 130. The other end of the threaded shafts 130 may be rotationally engaged with top support 120 within further bearings or equivalent rotational enablement. In this arrangement, when hand crank 140, or an electric motor, rotates worm gears 160, this motion is transmitted as rotational motion to threaded shafts 130. Traveling rod clamp 150 may be engaged with threaded shafts 130, as shown in FIG. 3, so that as shafts 130 rotate, clamp 50 translates vertically depending on which way the crank 140 is rotated.

Referring again to FIG. 1, a coupon rod 35 is mounted concentrically within coupon holder assembly 10. Coupon rod 35 is shown in a retracted position wherein a coupon mounting fixture 36 at a lower end of rod 35 is shown drawn upwardly into mounting tube 30. The upper end of rod 35 may be secured to traveling rod clamp 150 at clamping fixture 155 and may be centered on axis 60. Therefore, when crank 140 moves rod 35 downwardly within driver assembly 100, coupon mounting fixture 36 is moved downwardly into pipe 70 and when necessary, fixture 36 may be withdrawn from pipe 70 in the same manner. With valve 40 closed and mounting tube 30 brought to atmospheric pressure using bleed valve 37, so that at that time, a witness coupon (not shown) in mounting fixture 36 may be replaced.

While the invention has been described with reference to at least one preferred embodiment, it is to be clearly understood by those skilled in the art that the invention is not limited thereto.

What is claimed is:

1. An apparatus for moving a witness coupon into a high pressure pipe system, the apparatus comprising:
a coupon holder assembly;
a driver assembly secured to the coupon holder assembly at an upper end thereof;
a coupon rod engaged concentrically within the coupon holder assembly and the driver assembly, wherein, an upper end of the coupon rod is engaged with the driver assembly and a lower end of the coupon rod is positioned within the coupon holder assembly;
a clamp engaged with the coupon holder, the clamp adapted for clamping on the coupon rod for securing the coupon rod at a fixed position when the coupon rod is not being translated.

2. The apparatus of claim 1 wherein the driver assembly is enabled for moving the coupon rod in translational motion when the coupon rod is not secured by the clamp.

3. The apparatus of claim 1 wherein the driver assembly has a base block assembly with a mechanism for moving a traveling rod clamp in translational motion along an axis of the coupon holder assembly.

4. The apparatus of claim 3 wherein the mechanism has worm gears engaged with spur gears, the spur gears engaged with threaded shafts, the threaded shafts engaged with the traveling rod clamp, whereby rotation of the worm gears moves the traveling rod clamp in translation.

5. The apparatus of claim 1 wherein a bleed valve is mounted on the coupon holder assembly.

6. The apparatus of claim 1 wherein a ball valve is engaged with the apparatus for isolating the apparatus from a pipe.

7. The apparatus of claim 1 wherein a bleed valve is engaged with the apparatus for bleeding high pressure within the apparatus.
